(19) United States
(12) Patent Application Publication
(10) Pub. No.: US 2014/0222452 A1
(43) Pub. Date: Aug. 7, 2014

(54) METHOD AND SYSTEM FOR COMPILING AND DESIGNING CARE SUPPORT INFORMATION

(71) Applicant: Care Builders, Inc., Boise, ID (US)

(72) Inventor: Jennifer Moorman, Boise, ID (US)

(73) Assignee: Care Builders, Inc., Boise, ID (US)

(21) Appl. No.: 14/173,800

(22) Filed: Feb. 5, 2014

Related U.S. Application Data
(60) Provisional application No. 61/761,144, filed on Feb. 5, 2013.

(51) Int. Cl. G06Q 50/22; G06Q 10/10

(52) U.S. Cl. CPC G06Q 50/22; G06Q 10/10
USPC 705/2

(57) ABSTRACT

Methods and systems to enable users to select and compile personal care information filtered by the selection of a specific care concern or diagnosis, filtered by the user's geographic location, and filtered by available health care benefits. The method and system may provide information concerning home care assistance, transportation options, respite care, child care, home maintenance, shopping, pet care, technology, meal preparation, case management and advocacy services. Users may store information and post saved information to multiple planning boards for future reference or to share with others. The system and method may provide the total costs of services listed within the filtered information. Information concerning volunteer or barter opportunities may be provided to the user. The health care information may include links to various community, non-profit and governmental assistance entities. Users may purchase or be awarded credits to assist themselves or fellow users to access and utilize services contained within the system.

### RELATED APPLICATION

The present application claims the benefit of U.S. Provisional Patent Application Ser. No. 61/761,144, filed on Feb. 5, 2013 and entitled METHOD AND SYSTEM FOR COMPILING AND DESIGNING CARE SUPPORT INFORMATION, the disclosure of which is incorporated herein by reference in its entirety.

### FIELD OF THE DISCLOSURE

The present application generally relates to a method and system for compiling and designing care support information. The care support information may be filtered based on an individual's health care benefits (also referred to herein as care benefits, workplace benefits, employee-sponsored benefits, and/or benefits), which may include the individual's community, non-profit and government services. The care support information may also be filtered based on a location and a diagnosis or care service of interest.

### BACKGROUND

Numerous academic and commerce studies support the idea that employers are moving toward an environment of increased cost-sharing arrangements with employees to fund delivery of workplace benefits. Studies also indicate that employers are shifting resources to provide employees more information about existing benefits and services, but curtailing the expansion of benefits delivered to the employee via the employer's benefit plan. Research details the needs and desires of today's caregiver to receive information about care options that is (1) specific to their concern; (2) easily accessible; (3) affordable.

Evidence exists that the health and productivity of caregivers greatly increases when a strong support system exists. Support is found when caregivers are connected with individuals sharing a similar experience and by fostering positive family, workplace and social relationships. Numerous studies about the negative effects of caregiving on the workplace exist citing in part that working caregivers (1) have increased absenteeism; (2) decreased presenteeism; (3) increased likelihood to leave the workplace; (3) lower productivity; and (4) greater number of workday distractions and interruptions. The detrimental effects of caregiving cost employers hundreds of millions of dollars each year.

Research on the detrimental effects of caregiving on individuals indicate that caregivers (1) suffer substantially higher rates of depression than the average population; (2) experience significant losses of wages and retirement savings due to caregiving activities; (3) have poorer overall health than the general population; and (4) have increased levels of stress related to their caregiving responsibilities. Studies show that the detrimental effects of the caregiving relationship may be mitigated by providing the caregiver access to services and systems that support Instrumental Activities of Daily Living (IADL) including, but not limited to: transportation; housework; shopping; meal preparation; daily finances; dispensing medications; scheduling, coordinating and supervising services, e.g. home health, nursing, doctor's appointments, therapy.

Statistical evidence reveals that employer-sponsored benefits, community resources, non-profit agency assistance and government-sponsored assistance programs are underutilized because (1) those eligible for services are unaware of the existence of the benefit; (2) eligible individuals are overwhelmed by the process of searching for and accessing existing benefits; (3) eligible workers are concerned that utilizing benefits will have a negative impact on their relationship with their employer. Research reveals that when information is streamlined and customized to a specific topic of interest, comprehension of the information, compliance to the instructions provided in the information, and utilization of the resources presented in the information significantly increase when compared to results derived when individuals are presented with unlimited supplies of information. This process is referred to as mainstreaming and supports the development of a portal where users can access information customized to their specific concern.

Given that the caregiving relationship spans one's life from cradle to grave, it is evident that concerns about the responsibilities inherent to this basic condition touch the vast majority of adults in our society; effecting with increased intensity those who are employed and may be engaged in multiple caregiving roles. The number of individuals identifying themselves as caregivers steadily increases each year.

### SUMMARY

The present application discloses a method and system configured to compile and design care support information and that provides users a customized view of resources related to a specific care concern.

In one example, a method is disclosed for providing care information. The method comprises receiving a request for care information, determining a location of interest, determining a first individual's area of interest, and determining an individual's care benefits. The method further comprises populating at least one module with care information, the care information being filtered based on the determination of the location, the determination of the area of interest, and the determination of care benefits. The method further comprises providing a link to care information selected in the module by the first individual.

The location of interest may be a location of the first individual. Determining the location may be based on a zip code. The area of interest may be a diagnosis or a care service. The care benefits may be the first individual's care benefits. The care information may comprise at least one of workplace benefits, government programs, government resources, vendor services, community entities, non-profit entities, volunteer services, bartered services, care concern technology, group activities, or educational opportunities. The method may further comprise saving the care information for future use by the first individual. The method may further comprise referencing the care information on a personalized web page. The method may further comprise determining a total cost of services provided within the care information and providing the total cost to the first individual. The method may further comprise sending the care information to one or more recipients. The method may further comprise providing credits to be purchased or awarded by the first individual, wherein the credits may be used to purchase a service offered by a vendor, the service and vendor being listed in the care information populated in the at least one module. The method may further comprise determining whether the first individual desires to purchased credits for another individual. The method may further comprise adding purchased credits to an account of the first individual. The method may further comprise providing a code to the vendor, the code being associated with the account of the first individual. The method may further comprise receiving the code from the vendor for a purchase of the services by the first individual. The method may further comprise deducting an amount of credits from the first individual's account for the purchase of services. The method may further comprise providing a list of care services available via a barter or volunteer system. The method may further comprise providing an interface for the first individual to share information with other individuals.

In another example, a method is disclosed for providing care support information. The method comprises compiling data concerning care services and care programs, filtering the data based on a location, and filtering the data based on an individual's care benefits. The method further comprises filtering the data based on the individual's area of interest, and displaying the filtered data to the individual.

The method may further comprise determining a total cost of services and programs contained with the filtered data and displaying the total cost to the individual. The method may further comprise filtering the data based on services and programs available via bartering and displaying the filtered data to the individual.

In another example, a system is disclosed for providing care support information. The system comprises an engine configured to search for available care support information from a plurality of sources, a database configured to store care support information from the engine, and an index of the care support information stored in the database. The system further comprises a portal configured to access the index of care support information and to display the care support information, and a filter configured in response to a request from the portal to filter the indexed care support information based on a location, an individual's health care benefits, and the individual's area of interest.

### BRIEF DESCRIPTION OF THE DRAWINGS

FIG. 1 illustrates one example of a system for compiling and designing care support information including various modules.

FIG. 2 illustrates various user actions associated with a Care Builder module.

FIG. 3 illustrates various user actions associated with a Caring Exchange module.

FIG. 4 is a flow diagram illustrating one embodiment of a method of purchasing credits for acquiring services.

FIG. 5 is a flow diagram illustrating one embodiment of a method for providing health care information.

FIG. 6 is a flow diagram illustrating one embodiment of a method of providing care support information.

Like reference numbers and designations in the various drawings indicate like elements.

### DETAILED DESCRIPTION

Illustrative embodiments are described below as they might be employed in an apparatus and method for compiling and designing care support information. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Users may log on to one embodiment of a system for compiling and designing care support information, also referred to herein as health care information and care information, and indicate a geographic area determined by zip code and then select a diagnosis or care concern for which they desire information. The system may filter care support information based on the determination of geographic area and the diagnosis or care concern selected. Further, the system may filter care support information based on the user's health care benefits, which may include the user's community, non-profit, government and private vendor services.

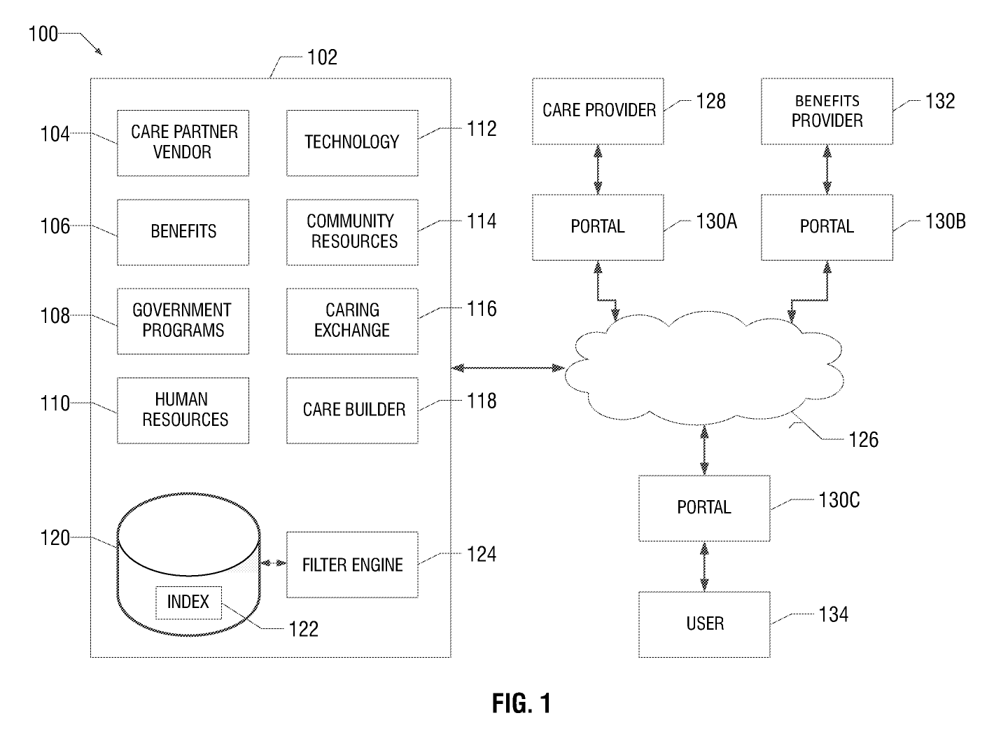

FIG. 1 illustrates one example of a system 100 for compiling and designing care support information including various modules. In the illustrated example, the system 100 includes an administrative site 102 comprising a Care Partner Vendor module 104, a Benefits module 106, a Government Programs module 108, a Human Resources module 110, a Technology module 112, a Community Resources module 114, a Caring Exchange module 116, and a Care Builder module 118. The administrative site 102 further comprises a database 120 having an index 122 and being in communication with a filter engine 124. In other examples, the administrative site 102 may comprise a variety of additional or alternative modules or other components.

In the illustrated example, the Care Partner Vendor module 104 may be accessible to vendors providing services related to IADLs. The Benefits module 106 may highlight specific language from workplace benefit policies that relate to a user's specific concern. The Government Programs module 108 may highlight descriptions and links to government programs related to a user's specific concern. The Human Resource module 110 may be accessible only to Human Resource professionals with content supporting implementation and management of workplace programs to support working caregivers. The Human Resources module 100 may also contain utilization reports detailing employee usage and areas of interest. The Technology module 112 may highlight descriptions and links to technology that may assist a caregiver with IADLs. The Community Resources module 114 may provide descriptions and links to community and non-profit services supporting a user's specific concern. The Caring Exchange module 116 may provide a forum devoted to building connection and community where users can view volunteer opportunities, barter, pool resources, or find information about groups and/or activities related to their specific concern. The Care Builder module 118 may provide a place to post and send saved information to visualize a plan to assist a user with meeting the responsibilities of caregiving.

As shown in FIG. 1, the administrative site 102 is in communication with a suitable telecommunications network 126, such as the Internet. The system 100 further comprises one or more care providers 128 in communication with the network 126 through a first portal 130A, one or more benefits providers 132 in communication with the network 126 through a second portal 130B, and one or more users 134 in communication with the network 126 through a third portal 130C. In operation, the care providers 128, benefits providers 130, and users 134 may gain access to the administrative site 102 over the network 126 through a suitable portal 130, such as a website. In some cases, a single website may serve as the first, second, and third portals 130A-C, whereas in other cases, each of the portals 130A-C may be unique.

In operation, the administrative site 102 gathers available information concerning care support services and/or programs, and stores the information in the database 120. The index 122 is created for the data stored within the database 120 so that it may be accessed in a personalized way by a user 134 of the administrative site 102. The filter engine 124 filters the indexed data to provide only relevant or desired information to a user 134 using a portal 130C to access the indexed information. The filter engine 124 may filter the indexed data using various filtering mechanisms. For example, the indexed data may be filtered based on location, health care benefits, and/or an area of interest of a user 134. The user 134 may enter filtering categories using the portal 130C so that personalized and/or relevant care information may be provided by the administrative site 102 to the user 134 at the portal 130C.

Users 134 may post information on the system 100 to share with other users 134 via the Caring Exchange module 116. In some cases, the information that may be posted is limited to the fields of choice contained with the Caring Exchange module 116. Users 134 may purchase credits for themselves or others to secure vendor services via an Account module (not shown). System-generated updates may be e-mailed or texted to users 134 to communicate important information and/or system updates. Employers or organizations who provide services to the users 134 of the system 100 may receive utilization data detailing characteristics of system usage and benefit to the sponsoring entity. In some cases, the information contained within the system 100 may be customized to meet the needs of a sponsoring organization and its workforce or membership.

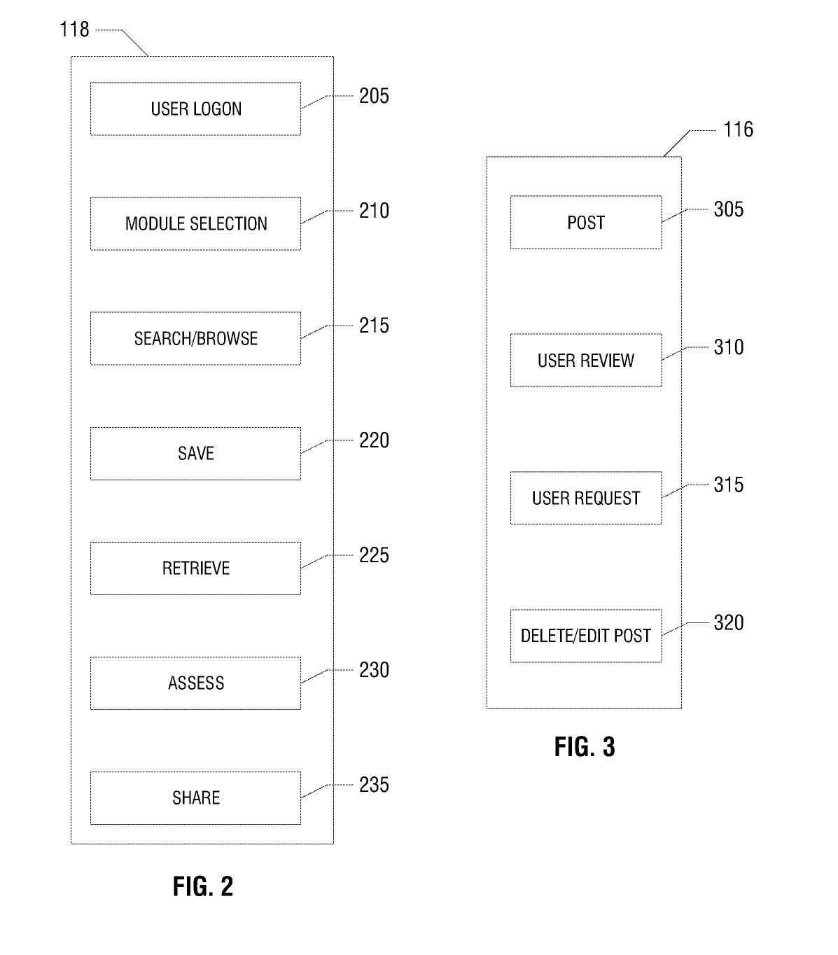

FIG. 2 illustrates various user actions associated with the Care Builder module 118 of the administrative site 102, which enable a user 134 to gain access to services, resources, and information. In operation, a user logon option 205 enables a user 134 to log onto the administrative site 102, select a diagnosis and/or care concern, and enter the user's zip code. A module selection option 210 enables the user 134 to select a module of interest to review information. The various modules of the administrative site 102 may be populated with care-specific information stored in the database 120, such as workplace benefits, government programs and resources, vendors providing support services, community and non-profit entities, individuals offering volunteer and/or bartered services, technology related to care concern, group activities and educational opportunities.

The Care Builder module 118 comprises a search/browse menu option 215, which enables the user 134 to search and browse the information stored in the selected module(s) and identify specific information of interest to the user 134. The Care Builder module 118 also comprises a save option 220, which enables the user 134 to save the specific information of interest in the user's Care Builder module 118 for future reference and/or contact the source information provider to seek additional information and secure services, if desired. The Care Builder module 118 also comprises a retrieve option 225, which enables the user 134 to reference saved search information stored in the user's Care Builder module 118. In some cases, the Care Builder module 118 may return the user 134 to the module containing similar care options when the user 134 selects the saved item and removes the “save” designation from the item, allowing the user 134 to review alternatives to the saved result. The Care Builder module 118 also comprises an assess option 230, which enables the user 134 to assess the cost of saved search options by reviewing a “Current Total” field displayed at the bottom of a web page displayed by the Care Builder module 118. The Care Builder module 118 may update cost estimates when the user 134 selects “Update” following a user-initiated change to the saved content. The Care Builder module 118 also comprises a share option 235, which enables the user 134 to send saved search information to other users 134.

FIG. 3 illustrates various user actions associated with the Caring Exchange module 116 of the administrative site 102, which enable a user 134 to post information to the administrative site 102. As shown in FIG. 3, the Caring Exchange module 116 comprises a post option 305, which enables the user 134 to post information to a Caring Exchange message board. The user 134 may create a post and add it to the message board by selecting a “save/post” button. The Caring Exchange module 116 also comprises a user review option 310, which enables the user 134 to create and post a user review on the Caring Exchange message board. Reviews can be posted for services contained in all of the modules of the administrative site 102 (except the Benefits module 106, in some cases) so the review corresponds directly to the specific service. In some implementations, reviews populate the service listing so they are evident when a user 134 selects a desired service or resource. In some cases, the user 134 may select an “add” function available on the Care Partner Vendors module 104 to post a review about a specific care provider. Other information on the Caring Exchange message board may include, for example, a donation, volunteer opportunity, barter request or group activity. The Caring Exchange module 116 also comprises a user request option 315, which enables the user 134 to submit a request to a system administrator for additional services or vendors. The Caring Exchange module 116 also comprises a delete/edit post option 320, which enables the user 134 to delete or edit a post saved by the user 134 on the Caring Exchange message board. The Caring Exchange module 116 may also delete time-sensitive posts for which the time of relevance and usefulness has passed.

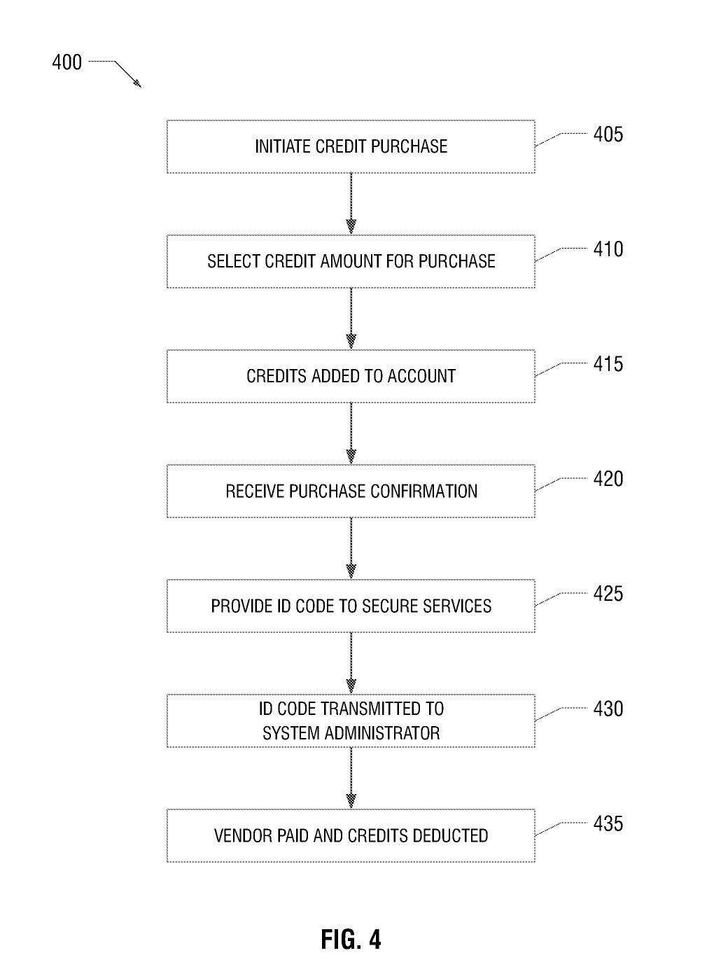

FIG. 4 is a flow diagram illustrating one embodiment of a method 400 of purchasing credits for the purpose of acquiring services featured on a system. In a first step 405, a user selects the “My Account” function and chooses, “Purchase Credits.” In a second step 410, a user selects the amount of credits to be purchased. The user may indicate if the credits are for personal use or to be used for the purchase of a “Care Card” for use by another authorized user of the system. In another step 415, the credits purchased for personal use are added to the user's account and listed on the user's profile. If the credits are for use by another user, the user enters the recipient's name and contact address (for example, e-mail and/or text) and selects a payment method. In another step 420, the user may receive an automated confirmation of purchase and delivery or the recipient may receive delivery of a “Care Card” notifying the individual that additional credits have been added to his or her account. In another step 425, the user provides the unique identification code associated with the user's account to an authorized vendor to secure services. In another step 430, the authorized vendor transmits the identification code to the system administrator for verification. In a final step 435, the system administrator provides the vendor an authorization code and deducts the number of credits needed to satisfy the transaction from the user's account.

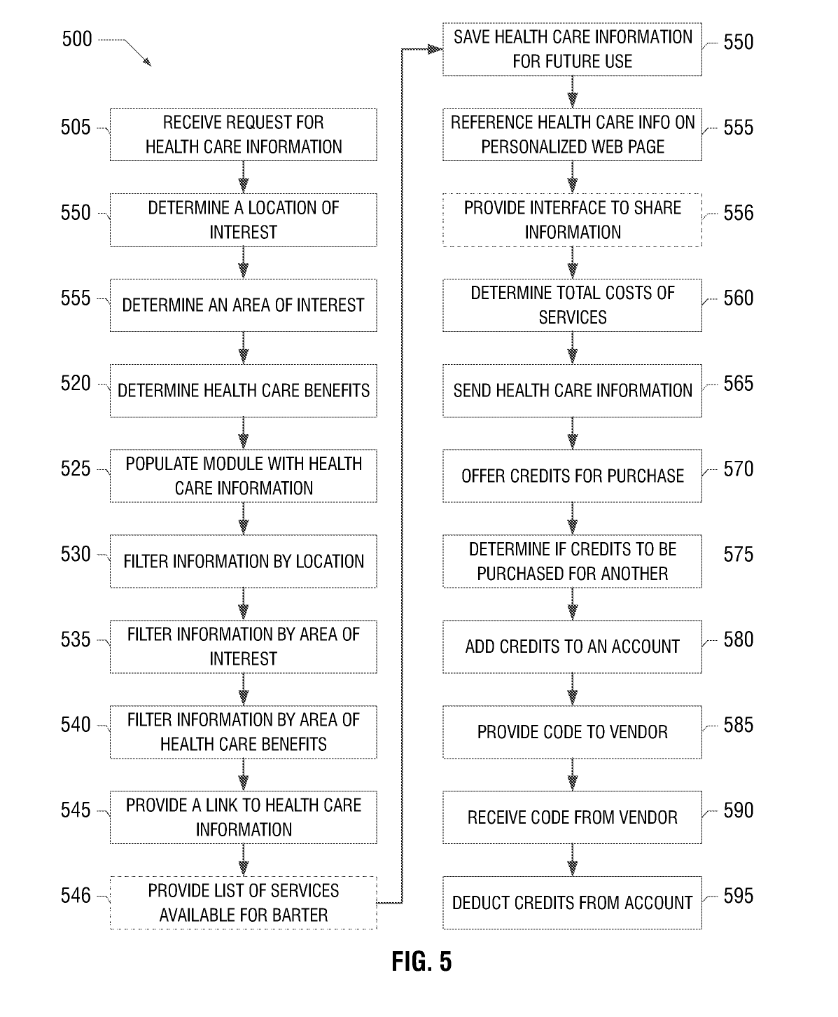

FIG. 5 is a flow diagram illustrating one embodiment of a method 500 for providing health care information. The method 500 includes a step 505 of receiving a request for care support information, also referred to as health care or care information. The request may be received from a portal at which a user logs onto an account of a system with a user name and password. At step 510, a location of interest is determined 510. The location of interest may be determined based on various mechanisms. For example, the physical location of the user at the time of login may be determined and used, or a zip code may be used to determine the location. The zip code may be listed on the user's account or may be entered into a field when requesting care information. The location may be the zip code for an individual other than the user of the system. At step 520, health care benefits are determined. The determined health care benefits may be the health care benefits available to the user based on the user's current benefits. Alternatively, the determined health care benefits may be the benefits for an individual other than the user of the system.

The user of the system may select a module and the module may be populated with health care information at step 525. The health care information populated within the module may be filtered by a location of interest at step 530. The health care information populated in the module may be filtered by an area of interest at step 535. For example, the selection of the module may cause the information to be filtered. Further, the user may select a care concern and/or diagnosis causing the filtering of the health care information. The health care information populated in the module may be filtered by health care benefits at step 540. The health care benefits may be the health care benefits of the user or the health care benefits of another individual. The health care benefits may be used to filter the information to only provide information concerning benefits and/or services available under the designated health care benefits. After filtering the health care information, in step 545 the system may provide a link or links to various services and/or resources within the health care information. In a step 546, the system may optionally provide a list of services that are available on a bartering system.

In a step 550, the filtered health care information may be saved for future use by the user. The user may be able to logon onto the system and review prior searches and filtered information that had been previously provided. In step 555, the user may be able to reference the health care information on a personalized web page. The personal web page may comprise a “My Care Planner” page and may include the health care information saved in step 550. The system may optionally provide in step 556 an interface that permits a user to share health care information. The interface may permit the user to post onto a board shared by users of the system. The saved information may also be shared with individuals who are not authorized users of the system. For example, the saved information may be e-mailed, printed, downloaded, etc., and shared with recipients who may or may not be authorized users. In addition, users may create, save and share multiple care plans.

After the health care information has been filtered, as discussed above, the information may include various services offered by vendors for a cost, which may be discounted due to having an account on the system. Step 560 determines an estimated total cost for the services contained within the provided health care information. In step 565, a user may be able to send the provided health care information to another user or individual. The user may be accessing a system for compiling and designing care support information for an elderly relation and may want to send the determined care support information to the elderly relation.

At step 570, the system may offer credits or care credits for purchase by the user of the system. Such credits may also be awarded to users to incentivize system usage or engage in other wellness or workplace activities. The credits may be used to purchase or order services identified in the provided care support information. As step 575, it is determined whether the purchase of the care credits is for the user or another individual. As step 580, the credits are added to the account of the purchaser or added to the account of an intended individual. The user may provide a unique identification code to a vendor of care services at step 585. The care services may be identified in the provided care information. The unique identification code is associated with the user's account and may be used to authorize the vendor to request credits from the user's account for a purchase. As step 590, the system administrator receives the unique identification code from an authorized vendor along with a request for verification of the purchase of services and at step 595 the credits for the purchase of services are deducted from the appropriate account.

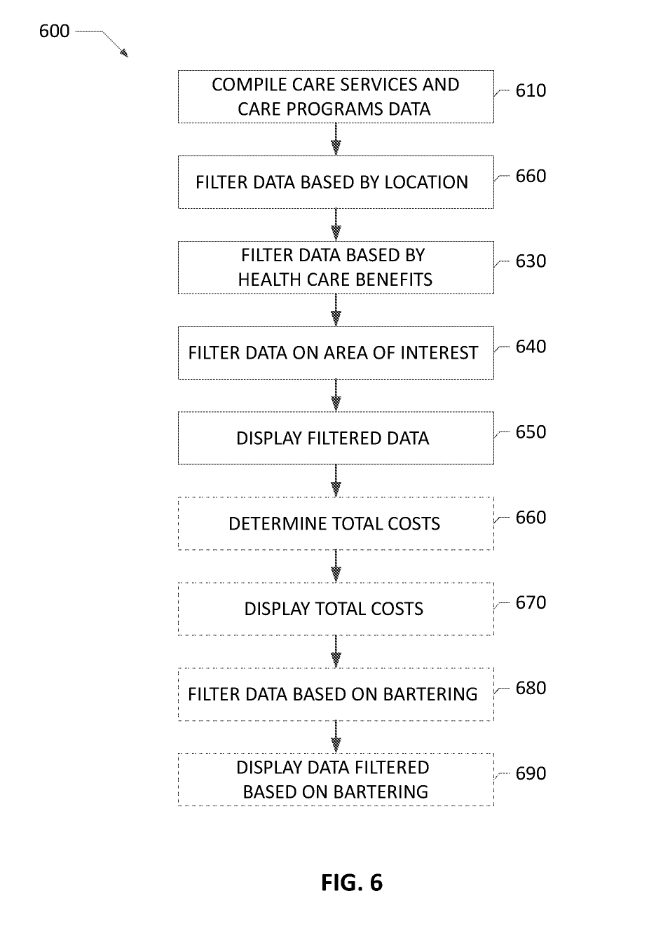

FIG. 6 shows an embodiment of a method 600 of providing care support information. The method comprises the step 610 of compiling data concerning care services and/or care programs. The data may be compiled using various search engines and resources and may be stored in a database. The data within the database may be filtered by various mechanisms to provide personalized care support information to an individual. For example, at step 620 the care support information, or data, may be filtered based on a location of interest. The location of interest may be the physical location of an individual requesting care support information, may be the physical location of an individual that a user is requesting care support information for, or may be a location of interest as designated by a user. At step 630, the care support information may be filtered by specific health care benefits or other resources. The specific health care benefits may be the benefits offered by an individual's employer's health care benefit plan, or the individual's current health care benefits, which may include the individual's government, non-profit, community or private vendor services or other resources. At step 640, the care support information may be filtered based on an individual's area of interest. The area of interest may be a diagnosis and/or a particular type of care.

At step 660, the total costs of services identified in the filtered care information may optionally be determined and displayed to a user at step 670. Optionally, the care information may be further filtered at step 680 to indicate services and/or programs that may be available through a bartering or volunteer system, which may be displayed to a user at step 690.

Although this disclosure has been described in terms of certain preferred configurations, other configurations that are apparent to those of ordinary skill in the art, including configurations that do not provide all of the features and advantages set forth herein, are also within the scope of this disclosure. Accordingly, the scope of the present disclosure is defined only by reference to the appended claims and equivalents thereof.

What is claimed is:

1. A method of providing care information, the method comprising:
receiving a request for care information;
determining a location of interest;
determining a first individual's area of interest;
determining an individual's care benefits;
populating at least one module with care information, the care information being filtered based on the determination of the location, the determination of the area of interest, and the determination of care benefits; and
providing a link to care information selected in the module by the first individual.

2. The method of claim 1, wherein the location of interest is a location of the first individual.

3. The method of claim 1, wherein determining the location is based on a zip code.

4. The method of claim 1, wherein the area of interest is a diagnosis or a care service.

5. The method of claim 4, wherein the care benefits are the first individual's care benefits.

6. The method of claim 4, wherein the care information comprises at least one of workplace benefits, government programs, government resources, vendor services, community entities, non-profit entities, volunteer services, bartered services, care concern technology, group activities, or educational opportunities.

7. The method of claim 4, further comprising saving the care information for future use by the first individual.

8. The method of claim 4, further comprising referencing the care information on a personalized web page.

9. The method of claim 4, further comprising determining a total cost of services provided within the care information and providing the total cost to the first individual.

10. The method of claim 4, further comprising sending the care information to one or more recipients.

11. The method of claim 4, further comprising providing credits to be purchased or awarded by the first individual, wherein the credits may be used to purchase a service offered by a vendor, the service and vendor being listed in the care information populated in the at least one module.

12. The method of claim 11, further comprising determining whether the first individual desires to purchased credits for another individual.

13. The method of claim 11, further comprising adding purchased credits to an account of the first individual.

14. The method of claim 13, further comprising providing a code to the vendor, the code being associated with the account of the first individual.

15. The method of claim 14, further comprising receiving the code from the vendor for a purchase of the services by the first individual.

16. The method of claim 15, further comprising deducting an amount of credits from the first individual's account for the purchase of services.

17. The method of claim 4, further comprising providing a list of care services available via a barter or volunteer system.

18. The method of claim 4, further comprising providing an interface for the first individual to share information with other individuals.

19. A method of providing care support information, the method comprising:
compiling data concerning care services and care programs;
filtering the data based on a location;
filtering the data based on an individual's care benefits;
filtering the data based on the individual's area of interest; and
displaying the filtered data to the individual.

20. The method of claim 19, further comprising determining a total cost of services and programs contained with the filtered data and displaying the total cost to the individual.

21. The method of claim 19, further comprising filtering the data based on services and programs available via bartering and displaying the filtered data to the individual.

22. A system for providing care support information, the system comprising:
an engine configured to search for available care support information from a plurality of sources;
a database configured to store care support information from the engine;
an index of the care support information stored in the database;
a portal configured to access the index of care support information and to display the care support information; and
a filter configured in response to a request from the portal to filter the indexed care support information based on a location, an individual's health care benefits, and the individual's area of interest.
